(19) United States
(12) Patent Application Publication
(10) Pub. No.: US 2009/0242774 A1
(43) Pub. Date: Oct. 1, 2009

(54) RADIATION DETECTOR

(75) Inventors: Hiromichi Tonami, Kyoto (JP); Junichi Ohi, Kyoto (JP)

Correspondence Address: J C PATENTS, INC., 4 VENTURE, SUITE 250, IRVINE, CA, 92618, US

(73) Assignee: SHIMADZU CORPORATION, Kyoto (JP)

(21) Appl. No.: 12/295,604

(22) PCT Filed: Apr. 4, 2006
(86) PCT No.: PCT/JP2006/307084

§ 371 Date: Sep. 30, 2008

(51) Int. Cl. G01T 1/20

(52) U.S. Cl. 250/361 R; 250/370.11

(57) ABSTRACT

A problem of local pin-hole defects generated in avalanche multiplication is avoided. Before an anode and a cathode are assembled as a light receiving element, a position of a pin-hole defect is specified by a vacuum container for specifying a defect position having a previously prepared field emission array for inspection. If the cathode is a field emission array when the anode and cathode are assembled as a light receiving element, the anode and cathode are assembled such that a field emission chip corresponding to the position of the pin-hole defect does not discharge an electron beam to the field emission array serving as an actual detector.

### BACKGROUND OF THE INVENTION

1. Field of the Invention

The present invention generally relates to a radiation detector, for example a positron emission tomography (PET) device, a single photon emission computed tomography (SPECT) device, or other medical diagnostic devices, in which the device detects a radioactive ray (gamma ray) discharged by radioactive isotopes (RIs) applied to a detected component and accumulated in a target portion, so as to obtain an RI distribution tomogram of the target portion.

2. Description of Related Art

The radiation detector includes scintillators being luminescent after the gamma ray discharged by the detected component is incident thereon, and photomultipliers converting the luminescence of the scintillators to a pulsed electric signal. For the radiation detector of the prior art, the scintillators and the photomultipliers are corresponding to one another one by one, but recently the following method is adopted, that is, the photomultipliers with a number less than that of the scintillators are combined with a plurality of scintillators, and according to a power ratio of the photomultipliers, the incident position of the gamma ray is determined, so as to improve the resolution (for example, please refer to patent document 1).

FIG. 12 is a cross sectional view in the X direction (front view) obtained by viewing a conventional radiation detector 150 from the Y direction. When the radiation detector is an isotropic voxel detector, a cross sectional view in the Y direction (side view) obtained by viewing the conventional radiation detector 150 from the X direction also has the same shape as that of FIG. 12. The radiation detector 150 includes a scintillator array 112, which is divided by appropriately sandwiching a light reflective material 113, and includes 36 scintillators 111 that are two dimensionally and compactly arranged in this manner of six scintillators in the X direction and six scintillators in the Y direction; a light guide 114, which is optically combined with the scintillator array 112 and is divided into a plurality of small blocks, and includes embedded lattice frames combined with a light reflective material 115; and four photomultipliers 301, 302, 303, and 304 optically combined with the light guide 114. In addition, in FIG. 12, only the photomultipliers 301 and 302 are shown. Here, the scintillators 111 for example use Bi₄Ge₃O₁₂ (BGO), Gd₂SiO₅:Ce (GSO), Lu₂SiO₅:Ce (LSO), LuYSiO₅:Ce (LYSO), LaBr₃:Ce, LaCl₃:Ce, NaI, CsI:Na, BaF₂, CsF, PbWO₄, and other inorganic crystals.

If the gamma ray is incident on any one of the six scintillators 111 arranged in the X direction, the gamma ray is converted to visible light. The light is guided to the photomultipliers 301-304 through the optically combined light guide 114. At this time, the position, length, and angle of each light reflective material 115 in the light guide 114 are adjusted, such that the power ratio of the photomultiplier 301 (303) to the photomultiplier 302 (304) arranged in the X direction is changed according to a fixed ratio.

Particularly, when the power of the photomultiplier 301 is set to P1, the power of the photomultiplier 302 is set to P2, the power of the photomultiplier 303 is set to P3, and the power of the photomultiplier 304 is set to P4, and the position and the length of the light reflective material 115 are set, such that a calculated value {(P1+P3)−(P2+P4)}/(P1+P2+P3+P4) representing a position in the X direction is changed in accordance with the position of each scintillator 111 at a fixed ratio.

In another aspect, for the six scintillators arranged in the Y direction, similarly the light is guided to the photomultipliers 301-304 through the optically combined light guide 114. That is, the position and the length of each light reflective material 115 in the light guide 114 are set, and the angle is adjusted under a situation of inclination, such that the power ratio of the photomultiplier 301 (302) to the photomultiplier 303 (304) arranged in the Y direction is changed at a fixed ratio.

That is, the position and length of the light reflective material 115 are set, such that the calculated value {(P1+P2)−(P3+P4)}/(P1+P2+P3+P4) representing a position in the Y direction is changed in accordance with the position of each scintillator at a fixed ratio.

Here, the light reflective material 113 between the scintillators 111 and the light reflective material 115 of the light guide 114 may use a silica and titania multi-layer film with a polyester film base material. The reflection efficiency of the multi-layer film is quite high, so it is used as the light reflective element. However, strictly, a part of the light may be transmitted because of the incident angle of the light. Therefore, the shape and disposition of the light reflective material 113 and the light reflective material 115 are determined according to the part of the transmitted light.

In addition, the scintillator array 112 is adhered to the light guide 114 by a coupling adhesive to form a coupling adhesive layer 116, and the light guide 114 is also adhered to the photomultipliers 301-304 by the coupling adhesive to form a coupling adhesive layer 117. Except for the surfaces optically combined with the photomultipliers 301-304, the peripheral surfaces which are not opposite to each scintillator 111 are covered by the light reflective material. At this time, the light reflective material mainly uses a polytetrafluoroethylene (PTFE) adhesive tape.

FIG. 13 is a block diagram of the structure of a position operating circuit of the radiation detector. The position operating circuit is formed by adders 121, 122, 123, and 124 and position determining circuits 125 and 126. As shown in FIG. 13, in order to detect the incident position of the gamma ray in the X direction, the power P1 of the photomultiplier 301 and the power P3 of the photomultiplier 303 are input to the adder 121, and the power P2 of the photomultiplier 302 and the power P4 of the photomultiplier 304 are input to the adder 122. The added powers (P1+P2) and (P3+P4) output by the two adders 121 and 122 are input to the position determining circuit 125, and the incident position of the gamma ray in the X direction is obtained according to the two added powers.

Similarly, in order to detect the incident position of the gamma ray in the Y direction, the power P1 of the photomultiplier 301 and the power P2 of the photomultiplier 302 are input to the adder 123, and the power P3 of the photomultiplier 303 and the power P4 of the photomultiplier 304 are input to the adder 124. The added powers (P1+P2) and (P3+P4) output by the two adders 123 and 124 are input to the position determining circuit 126, and the incident position of the gamma ray in the Y direction is obtained according to the two added powers.

In addition, the calculated value (P1+P2+P3+P4) represents the energy relative to the event, and is represented by an energy spectrum as shown in FIG. 14.

For the result calculated with the previous method, it is represented by a position coding map as shown in FIG. 15 according to the positions of the gamma ray incident on the scintillators, and it represents the determined information of each position.

In another aspect, methods for improving the spatial resolution by realizing block detectors having the depth of interaction (DOI) information are proposed, for example a method of compactly disposing the scintillator arrays respectively formed by materials with different luminescence decay time in multiple stages (for example please refer to non patent document 1), or a method of disposing each scintillator array in this manner of being spaced by a half pitch (for example please refer to non patent document 2) and the like.

In the plurality of the examples in the prior art, the photomultiplier is used as a light receiving element receiving the light emitted by any scintillator. For the radiation detector 160 as shown in FIG. 16, recently, semiconductor light receiving elements called avalanche photodiodes 401-404 are also used. The avalanche photodiodes are used in an avalanche state by applying a high electric field in a silicon depletion layer, so as to perform a signal amplification. A signal amplification factor of the avalanche photodiode is 50 to 100 times, which is smaller than the amplification factor of the photomultiplier of 105 to 106 times; however, the avalanche photodiode can be applied by using a low noise amplifier or in a low temperature environment. As the avalanche is generated in a thinner silicon depletion layer, compared with the photomultiplier, the avalanche photodiode serving as the light receiving element is quite thin, such that under a situation that the space is limited, it is extremely effective to a detector in the PET device.

In another aspect, as shown in FIG. 17, the inventors of the application provide a detector 170 having the avalanche multiplication film and the field emission arrays serving as the light receiving elements 501-504. In addition, FIG. 17 only shows the light receiving elements 501 and 502, and omits the light receiving elements 503 and 504. After converting the light from the scintillator to the electric signal by using the avalanche multiplication film formed by amorphous selenium, the detector 170 reads the electric signal by using the electron beam from a plurality of field emission chips of the field emission array. The avalanche multiplication film and the field emission arrays are disposed in a vacuum-sealed vacuum enclosure, the detector 170 is quite thin, and the structure of the detector 170 is simple. Thus, the detector 170 can be more compact than a detector using the photomultipliers. It is different from the photomultiplier requiring a plurality of electrodes, so the structure is simple, and the detector may be realized at a low cost. For the avalanche multiplication film formed by amorphous selenium, the signal amplification factor may be up to 1000 times, so it does not require any expensive low noise amplifier or the dedicated temperature adjusting mechanism performing the low temperature operation required in the avalanche photodiode. In addition, even if LaBr₃:Ce or LaCl₃:Ce is used, the quantum efficiency of the avalanche multiplication film in the wavelength band of 300-400 nm also achieves 70%, so compared with the photomultipliers or the avalanche photodiodes, it has an advantage of high efficiency. In addition, the detailed structure of the light receiving element 501 is illustrated as follows.

FIG. 18 shows a detector 180 in which the avalanche multiplication film and the reading substrate are connected by bump electrodes and serve as the light receiving elements 601-604. In addition, FIG. 17 only shows the light receiving elements 601 and 602, and omits light receiving elements 603 and 604. The detector 180 selectively retrieves and reads the signal through the connecting with a reading substrate on which a plurality of small bump electrodes are formed. The avalanche multiplication film and the reading substrate are connected in the structure, so the detector 180 is quite thin and the structure of the detector 180 is simple, such that as compared with the detector using the photomultipliers, the detector 180 is more compact, and can be realized at a low cost. In addition, the detailed structure of the light receiving element 601 is illustrated as follows.

Patent Document 1: Japanese Patent Publication Number 2004-354343

Non Patent Document 1: S. Yamamoto and H. Ishibashi, A GSO depth of interaction detector for PET, IEEE Trans. Nucl. Sci., 45:1078-1082, 1998.

Non Patent Document 2: H. Liu, T. Omura, M. Watanabe, et al., Development of a depth of interaction detector for g-rays, Nucl. Instr., Meth., Physics Research A 459:182-190, 2001.

For the light receiving element using the avalanche multiplication film formed by amorphous selenium in the previous examples of the prior art, although it has better performance than the photomultiplier or avalanche photodiode, it has the following problems.

In the light receiving element using the avalanche multiplication film formed by the amorphous selenium, during the avalanche multiplication, to generate a high electric field of approximately 100 V/μm in the amorphous selenium film, it is necessary to apply a higher bias voltage, such that even if a protrusion of approximately 0.1 μm is for example formed on the transparent glass panel in the light receiving surface, a non-uniform electric field may be generated at this time, resulting in a local pin-hole defect, which eventually leads to a short circuit. When the light receiving surface is formed by only a single pole, even if a short circuit occurs only on a portion, it is impossible for the whole light receiving surface to operate.

### SUMMARY OF THE INVENTION

In order to solve the problems, a radiation detector of claim 1 of the present invention includes a scintillator array performing a light conversion on a radioactive ray and light receiving elements, in which the light receiving elements include: a vacuum enclosure, disposed on a surface opposite to an incident direction of the radioactive ray of the scintillator array, and being vacuum-sealed; a transparent electrode, disposed in the vacuum enclosure; an avalanche multiplication film, formed on the transparent electrode, sandwiched between barrier layers, and formed by amorphous selenium; and a field emission array, disposed opposite to the avalanche multiplication film, and having a plurality of field emission chips. The radiation detector is characterized in that when a defect portion exists on the avalanche multiplication film, the field emission chip at an opposite position to the defect portion is made to not operate.

According to the radiation detector of claim 1, the radiation detector of claim 2 is characterized in that at least one surface of the vacuum enclosure is formed by a transparent glass panel, and the transparent electrode is formed on the transparent glass panel.

According to the radiation detector of claim 1 or 2, the radiation detector of claim 3 is characterized in that a light guide for performing a light sharing adjustment is disposed between the scintillator array and the light receiving elements.

According to the radiation detector of any one of claims 1 to 3, the radiation detector of claim 4 is characterized in that the field emission chip at the position opposite to the defect portion is burnt by a laser, thereby not performing an operation of discharging an electron beam.

The radiation detector of claim 5 includes: a scintillator array, performing a light conversion on a radioactive ray; a transparent glass panel, disposed on an surface opposite to an incident direction of the radioactive ray of the scintillator array; a transparent electrode, formed on the transparent glass panel; an avalanche multiplication film, formed on the transparent electrode, sandwiched between barrier layers, and formed by amorphous selenium; and a unit, connected to a reading substrate including a plurality of small bump electrodes and selectively retrieving a signal. The radiation detector is characterized in that when a defect portion exists on the avalanche multiplication film, the small bump electrodes are made to not connect to the defect portion.

According to the radiation detector of claim 5, the radiation detector of claim 6 is characterized in that a light guide for performing a light sharing adjustment is disposed between the scintillator array and the light receiving element.

According to the radiation detector of claim 5 or 6, the radiation detector of claim 7 is characterized in that the bump electrodes are not formed at a position corresponding to the defect portion of the avalanche multiplication film.

In addition, an inspecting method of a radiation detector of claim 8 is characterized in that: in a vacuum container for specifying a defect position having a field emission array for inspection, a transparent glass panel and a transparent electrode formed on the transparent glass panel are disposed opposite to an avalanche multiplication film formed on the transparent electrode and sandwiched between barrier layers, and a position of a defect portion on the avalanche multiplication film generated in an avalanche operation is specified.

That is, before the anode and the cathode are assembled as a light receiving element, in the vacuum container for specifying a defect position having the previously prepared field emission array for inspection, the transparent glass panel and the transparent electrode formed on the transparent glass panel are disposed opposite to the avalanche multiplication film formed on the transparent electrode and sandwiched between barrier layers, and the position of the pin-hole defect in a light receiving surface generated in an avalanche operation is specified.

If the cathode is a field emission array when the anode and cathode are assembled as an actual light receiving element, the anode and cathode are assembled such that a field emission chip corresponding to the position of the pin-hole defect does not discharge an electron beam to the field emission array serving as the detector. At this time, as an insensitive part, the light receiving surface corresponding to the specified position of the pin-hole defect does not function, but the area of the insensitive part is quite limited and very small, and other parts are sensitive parts. Therefore, the detector can function normally.

In addition, if the cathode is a reading substrate having a plurality of small bump electrodes when the anode and cathode are assembled as the actual light receiving element, the anode and the cathode are assembled in the following manner: the small bump electrodes of the reading substrate are only connected to parts except for the specified pin-hole defect portions before the connection, but not connected to the defect portion. At this time, as an insensitive part, the light receiving surface corresponding to the specified position of the pin-hole defect does not function, but the area of the insensitive part is quite limited and very small, and other parts are sensitive parts. Therefore, the detector can function normally.

### EFFECT OF THE INVENTION

The following effect is achieved through the above functions: the problem of the local pin-hole defect in the avalanche multiplication is prevented.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross sectional view in the X direction of a radiation detector according to a first embodiment of the present invention.

FIG. 2 is a cross sectional view viewed from an upper surface of the radiation detector according to the first embodiment of the present invention.

FIG. 3 is a detailed cross sectional view of the radiation detector according to the first embodiment of the present invention.

FIG. 4 is a detailed cross sectional view of a vacuum container for specifying a defect position according to the first embodiment of the present invention.

FIG. 5 is a detailed cross sectional view of the processing before assembly according to the first embodiment of the present invention.

FIG. 6 is a cross sectional view in the X direction of the radiation detector after the processing of the first embodiment of the present invention is performed.

FIG. 7 is a cross sectional view in the X direction of the radiation detector according to a second embodiment of the present invention.

FIG. 8 is a cross sectional view viewed from the upper surface of the radiation detector according to the second embodiment of the present invention.

FIG. 9 is a detailed cross sectional view of the radiation detector according to the second embodiment of the present invention.

FIG. 10 is a detailed cross sectional view of the processing before assembly according to the second embodiment of the present invention.

FIG. 11 is a cross sectional view in the X direction of the radiation detector after the processing of the second embodiment of the present invention is performed.

FIG. 12 is a cross sectional view in the X direction of a conventional radiation detector.

FIG. 13 shows an example of a position operating circuit of the radiation detector of the present invention and the conventional radiation detector.

FIG. 14 is an energy spectrum of the radiation detector of the present invention and the conventional radiation detector.

FIG. 15 is a position coding map of the radiation detector of the present invention and the conventional radiation detector.

FIG. 16 is a cross sectional view in the X direction of the conventional radiation detector.

FIG. 17 is a cross sectional view in the X direction of the conventional radiation detector.

FIG. 18 is a cross sectional view in the X direction of the conventional radiation detector.

### DESCRIPTION OF SYMBOLS

10 radiation detector of the first embodiment of the present invention
11 scintillator
12 scintillator array
13 light reflective material
14 light guide
15 light reflective material
16 coupling adhesive layer
17 coupling adhesive layer
21 transparent glass panel
22 transparent electrode
23 hole injection barrier layer
24 avalanche multiplication film
25 electron injection barrier layer
26 field emission chip
27 field emission array
28 shared gate electrode
29 mesh electrode
30 electron beam
31 vacuum enclosure
32 shared gate electrode bias
33 mesh gate electrode bias
34 bias
35 amplifier
40 anode
41 cathode
51 vacuum container
52 flange
53 jig
54 field emission chip for inspection
55 field emission array for inspection
56 shared gate electrode for inspection
57 mesh electrode for inspection
58 electron beam
59 shared gate electrode bias for inspection
60 mesh electrode bias for inspection
61 bias for inspection
62 amplifier for inspection
63 switch
64 switch
65 vacuum container 65 for specifying a defect position
70 pin hole defect
71 processed field emission chip
80 radiation detector of the second embodiment of the present invention
81 small bump electrode 82 reading substrate
83 bias
84 amplifier
90 anode
91 cathode
101, 102, 103, 104 light receiving elements of the first embodiment of the present invention
111 scintillator
112 scintillator array
113 light reflective material
114 light guide
115 light reflective material
116 coupling adhesive layer
117 coupling adhesive layer
121, 122, 123, 124 adder
125, 126 position determining circuits
150 conventional radiation detector using photomultiplier
160 conventional radiation detector using photomultiplier
201, 202, 203, 204 light receiving elements of the second embodiment of the present invention
301, 302, 303, 304 photomultiplier
401, 402, 403, 404 avalanche photodiode
501, 502, 503, 504 light receiving elements
601, 602, 603, 604 light receiving elements

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### The First Embodiment

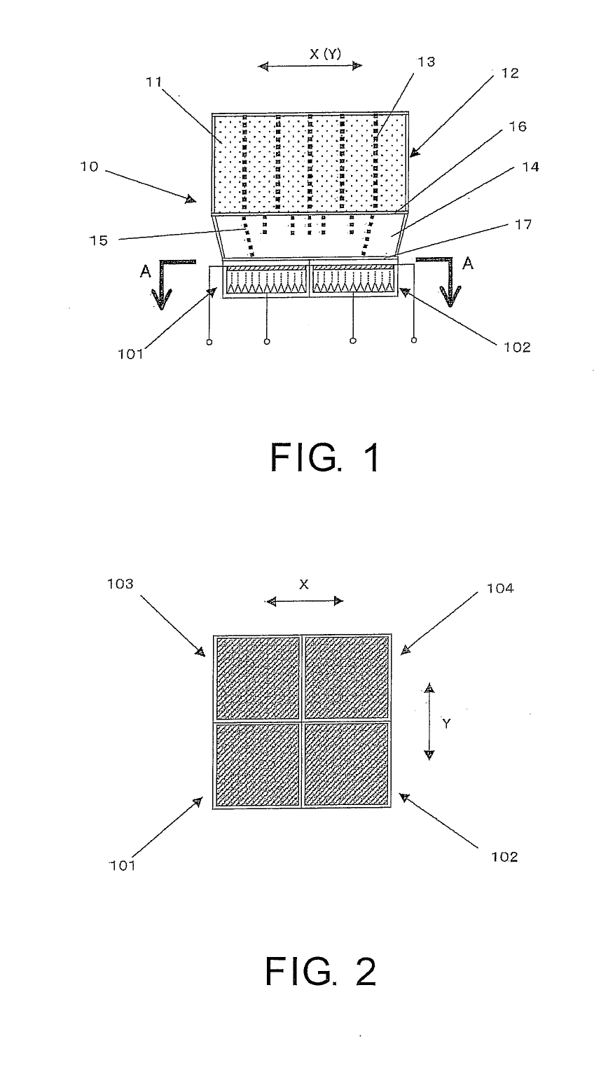

The drawings show the structure of the first embodiment of a radiation detector of the present invention, and the detailed illustration is given according to the embodiment. FIG. 1 is a cross sectional view in the X direction obtained by viewing a radiation detector 10 from the Y direction. In this embodiment, an isotropic voxel detector is described, so a cross sectional view in the Y direction (side view) obtained by viewing the radiation detector 10 from the X direction also has the same shape as that of FIG. 1. The radiation detector 10 includes a scintillator group 12, which is divided by appropriately sandwiching a light reflective material 13, and includes 36 scintillators 11 that are two dimensionally and compactly arranged in a manner of six scintillators in the X direction and six scintillators in the Y direction; a light guide 114, which is optically combined with the scintillator group 12 and is divided into a plurality of small blocks, and includes embedded lattice frames combined with a light reflective material 15; and four light receiving elements 101, 102, 103, and 104 optically combined with the light guide 14. Here, all the light receiving elements 101-104 are the same. In addition, in FIG. 1, only the light receiving elements 101 and 102 are shown. Here, the scintillators 11 for example use Bi₄Ge₃O₁₂ (BGO), Gd₂SiO₅:Ce (GSO), Lu₂SiO₅:Ce (LSO), LuYSiO₅:Ce (LYSO), LaBr₃:Ce, LaCl₃:Ce, NaI, CsI:Na, BaF₂, CsF, PbWO₄, and other inorganic crystals.

If the gamma ray is incident on any one of the six scintillators 11 arranged in the X direction, the gamma ray is converted to visible light. The light is guided to the light receiving elements 101˜104 through the optically combined light guide 14. At this time, the position, length, and angle of each light reflective material 115 in the light guide 114 are adjusted, such that the power ratio of the light receiving element 101 (103) to the photomultiplier 102 (104) arranged in the X direction is changed at a fixed ratio.

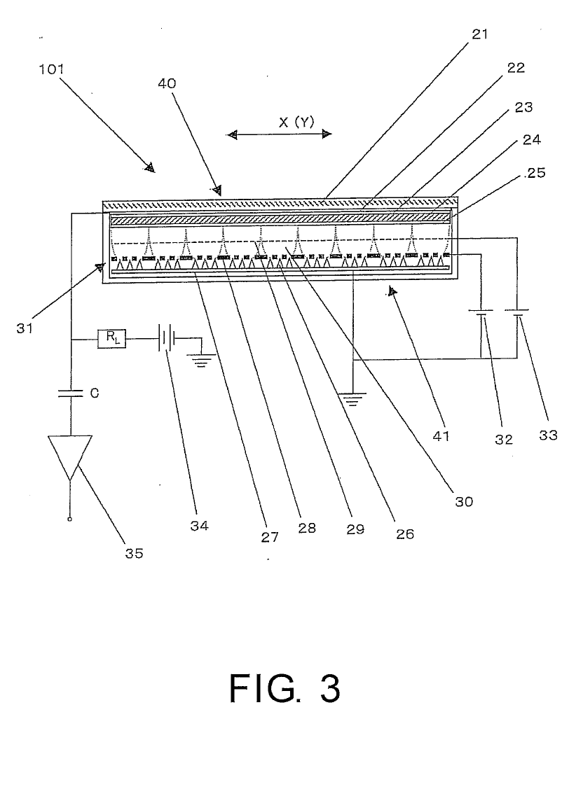

FIG. 2 is a cross sectional view of FIG. 1 taken along A-A, which is obtained by viewing the light receiving elements 101, 102, 103, and 104 of the present invention from an upper surface. In addition, FIG. 3 shows the light receiving element 101 (102, 103, and 104 are the same, so only 101 is shown as a representative) in detail. In FIG. 3, an anode 40 includes a transparent glass panel 21; a transparent electrode 22, formed on the transparent glass panel 21; a hole injection barrier layer 23, formed on the transparent electrode 22; an avalanche multiplication film 24, formed on the hole injection barrier layer 23 and formed by amorphous selenium; and an electron injection barrier layer 25, formed on the avalanche multiplication film 24. In another aspect, a cathode 41 is formed in the following manner. A field emission array 27 formed by a plurality of field emission chips 26 is disposed opposite to the anode 40, and a shared gate electrode bias 32 is applied on a shared gate electrode 28, such that the electron beam 30 is radiated towards the anode 40. At this time, the electron beam 30 reaches the anode in this manner of soft landing after being decelerated by a mesh electrode 29. A mesh electrode bias 33 is applied on the mesh electrode 29. Here, in order to make the anode 40 including the avalanche multiplication film 24 and the cathode 41 including the field emission array 27 vacuum-sealed, the anode 40 and the cathode 41 are assembled in a vacuum enclosure 31. An actual distance between the avalanche multiplication film 24 and the field emission array 27 is approximately from 1 mm to 2 mm, so the light receiving element 101 is quite thin.

Here, if the gamma ray is incident on any one of the scintillators 11, the gamma ray is converted to a visible light. The light is guided to the light receiving elements 101˜104 through the optically combined light guide 14. After passing through the transparent glass panel 21 and the transparent electrode 22 in each light receiving element, the light reaches the avalanche multiplication film 24 formed by amorphous selenium, and generates electron-hole pairs through a photoelectric conversion. A bias 34 is applied on the avalanche multiplication film 24. In the film, the signal is amplified when a hole moves from the anode 40 to the cathode 41, and the amplified holes appear opposite to the field emission array 27 on the surface of the avalanche multiplication film 24. The electron beam 30 is radiated from the field emission array 27, so the amplified holes are immediately scanned, and is read by an amplifier.

At this time, when the thickness of the avalanche multiplication film 24 is set to 35 μm, and the voltage of the applied bias 34 is set to 3500 V, the signal amplification factor is up to 1000 times, so as to detect the gamma ray with a high sensitivity.

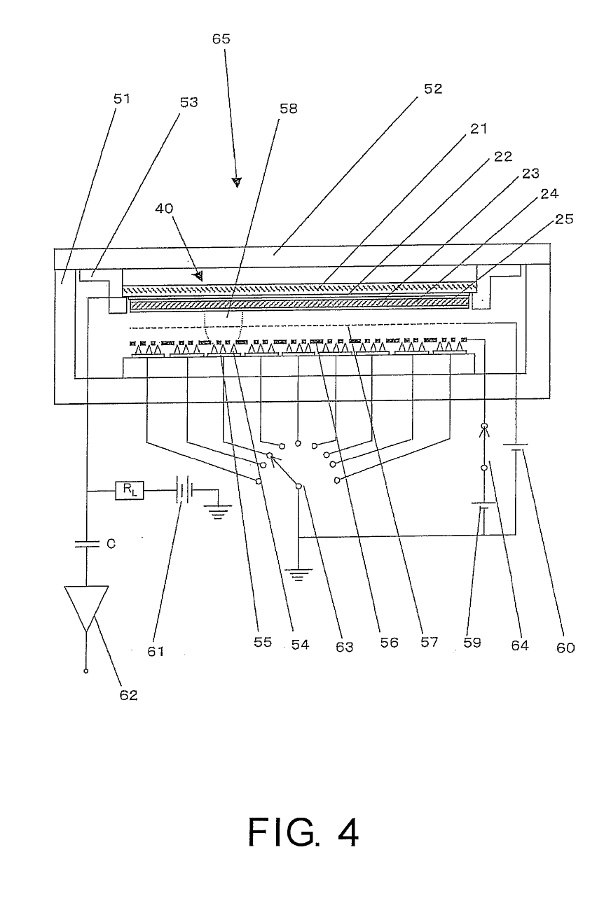

However, at this time, in order to generate a high electric field of approximately 100 V/μm in the amorphous selenium film, it is necessary to apply a high bias voltage on the avalanche multiplication film 24, such that even if a protrusion of approximately 0.1 μm is for example formed on the transparent glass panel 21 in the light receiving surface, a non-uniform electric field may be generated at this time, resulting in a local pin-hole defect, which eventually leads to a short circuit. When the light receiving surface is formed by only a single pole, even if the short circuit occurs on only a portion, it is impossible for the whole light receiving surface to operate. Therefore, before the anode 40 and the cathode 41 are assembled as the light receiving element, it is necessary to perceive the position of the pin-hole defect in advance. Therefore, the position of the pin-hole defect is specified with the following method. As shown in FIG. 4, the anode 40 is held on a jig 53 for holding the transparent glass panel, in the vacuum container 65 for specifying a defect position having a previously prepared field emission array for inspection 55, the anode 40 is disposed opposite to the field emission array for inspection 55, in which the anode 40 includes: a transparent glass panel 21; a transparent electrode 22, formed on the transparent glass panel 21; a hole injection barrier layer 23, formed on the transparent electrode 22; an avalanche multiplication film 24, formed on the hole injection barrier layer 23 and formed by amorphous selenium; and an electron injection barrier layer 25, formed on the avalanche multiplication film 24. At this time, the bias voltage 61 required to generate the avalanche amplification is applied, and the power of the amplifier 62 is monitored. Next, a switch 63 connected to the field emission array for inspection 55, and a switch 64 connected to the shared gate electrode 56 (a plurality of the shared gate electrodes exist in the direction vertical to the paper, not shown here) are switched in sequence. Therefore, during a certain period, the electron beam 58 is only radiated from the field emission array for inspection 55 towards a unit of a small area, and from front ends of field emission chips for inspection 54 in sequence. That is, the part scanned by the field emission array for inspection 55 becomes the unit of a small area, so as to inspect whether the part has the pin-hole defect or not. Therefore, the position of the pin-hole defect in the light receiving surface generated in the avalanche operation can be specified. In addition, the vacuum container 65 for specifying a defect position is formed by a vacuum container 51 and a flange 52, and the anode 40 is installed in this manner of being spaced by the jig 53 for holding the transparent glass panel, so as to form a structure capable of being opened and closed for many times.

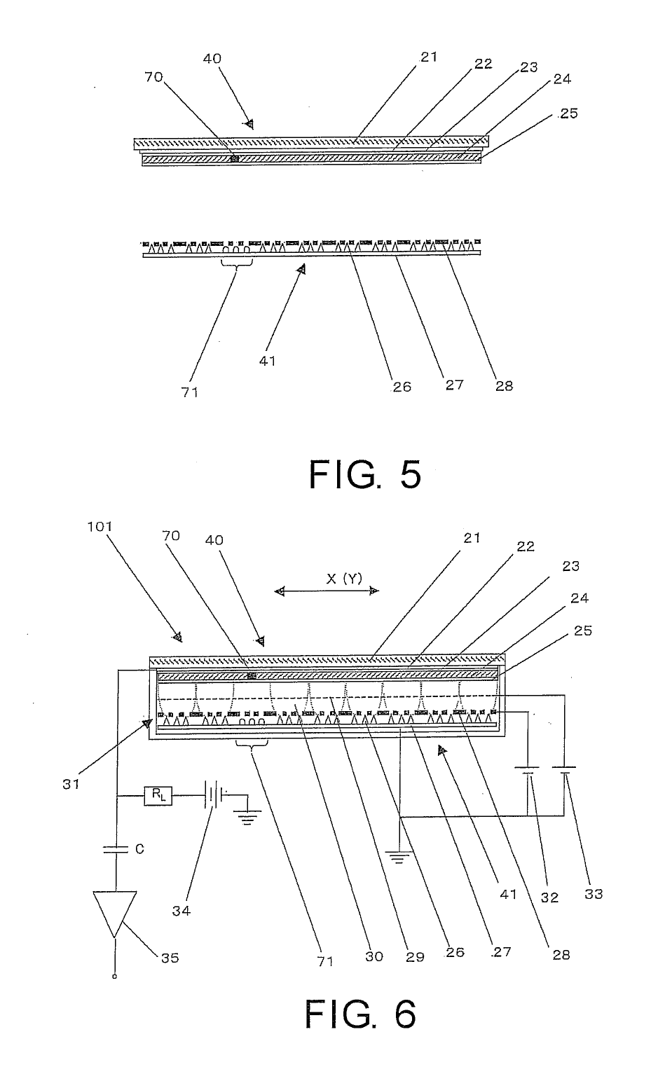

Next, FIG. 5 shows the inspected anode 40 and the processed cathode 41 before being assembled as the light receiving element 101. As it is possible to specify the position of the pin-hole defect 70 in the light receiving surface of the anode 40, the processed field emission chip 71 corresponding to the position of the pin-hole defect 70 will not discharge an electron beam to the field emission array 27 of the cathode 41. The example of FIG. 5 shows the processed field emission chip 71, which is achieved by burning the protruding part by irradiating laser on the front end portion, so as not to discharge the electron beam.

In addition, FIG. 6 shows the situation after the light receiving element 101 is assembled. As described above, the field emission chip 71 corresponding to the position of the pin-hole defect 70 does not discharge an electron beam, and the field emission chips 26 except for the field emission chip 71 corresponding to the position of the pin-hole defect 70 discharge the electron beam. Therefore, even if the high bias voltage is applied on the avalanche multiplication film 24 in the amorphous selenium film for a signal amplification, it is impossible to become the local pin-hole defect and result in a short circuit, such that the area of the light receiving surface except for the pin-hole defect 70 can function normally.

At this time, as an insensitive part, the light receiving surface corresponding to the position of the pin-hole defect 70 does not function, but the area of the insensitive part is quite limited and very small, and other parts are sensitive parts. Therefore, the detector can function normally.

### The Second Embodiment

The drawings show the structure of the second embodiment of the radiation detector of the present invention, and the detailed illustration is given according to the embodiment. FIG. 7 is a sectional view in the X direction obtained by viewing a radiation detector 80 from the Y direction. In this embodiment, an isotropic voxel detector is described, so a sectional view in the Y direction (side view) obtained by viewing the radiation detector 80 from the X direction also has the same shape as that of FIG. 7. The radiation detector 80 includes a scintillator group 12, which is divided by appropriately sandwiching a light reflective material 13, and includes 36 scintillators 11 that are two dimensionally and compactly disposed in this manner of six scintillators in the X direction and six scintillators in the Y direction; a light guide 114, which is optically combined with the scintillator group 12 and is divided into a plurality of small blocks, and includes embedded lattice frames combined with a light reflective material 15; and four light receiving elements 201, 202, 203, and 204 optically combined with the light guide 114. Here, all the light receiving elements 201˜204 are the same. In addition, in FIG. 7, only the light receiving elements 201 and 202 are shown.

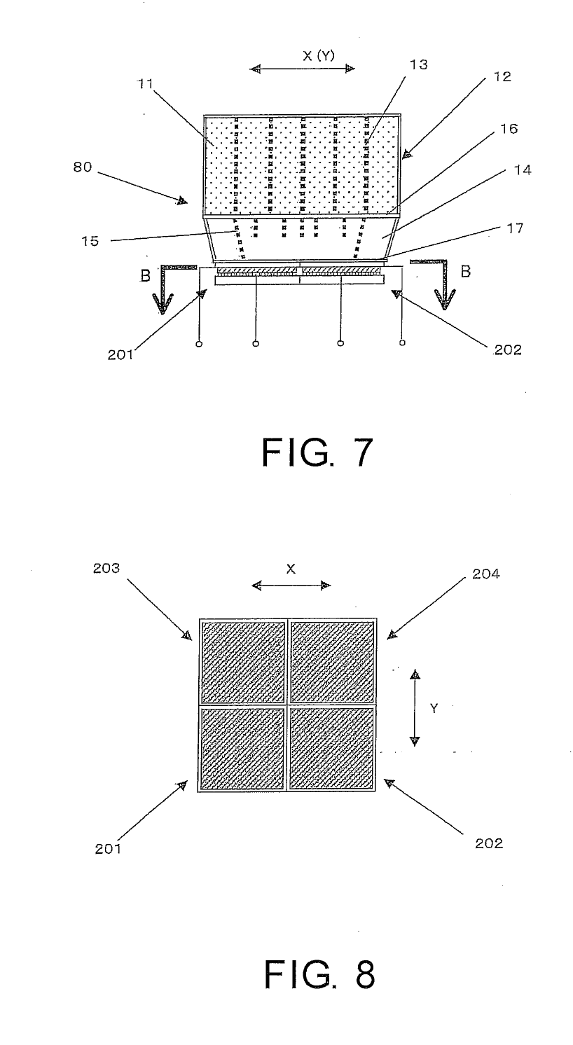

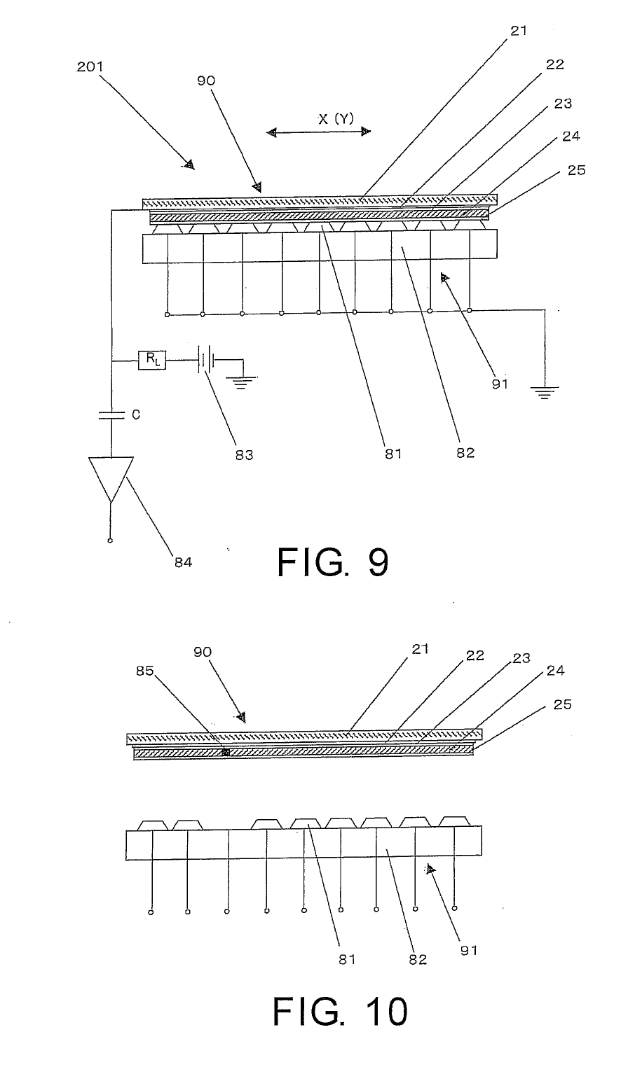

FIG. 8 is a sectional view of FIG. 7 taken along B-B, which is obtained by viewing the light receiving elements 201, 202, 203, and 204 of the present invention from an upper surface. In addition, FIG. 9 shows the light receiving element 201 (202, 203, and 204 are the same, so only 201 is shown as a representative) in detail. In FIG. 9, an anode 90 includes a transparent glass panel 21; a transparent electrode 22, formed on the transparent glass panel 21; a hole injection barrier layer 23, formed on the transparent electrode 22; an avalanche multiplication film 24, formed on the hole injection barrier layer 23 and formed by amorphous selenium; and an electron injection barrier layer 25, formed on the avalanche multiplication film 24. In another aspect, the structure of the cathode 41 is formed by a reading substrate 82 having a plurality of small bump electrodes 81, in which the signal is read by connecting the avalanche multiplication film 24 and the small bump electrodes 81. The signal is selectively retrieved and read by changing the connection of the small bump electrodes 81. In the example of FIG. 9, all the small bump electrodes 81 are electrically connected. In the light receiving element 201, the height of the small bump electrodes 81 is several micrometers, and the thickness of the reading substrate 82 is also from 1 mm to 2 mm, so the light receiving element 201 is quite thin.

Here, if the gamma ray is incident on any one of the scintillators 11, the gamma ray is converted to a visible light. The light is guided to the light receiving elements 201˜204 through the optically combined light guide 14. After passing through the transparent glass panel 21 and the transparent electrode 22 in each light receiving element, the light reaches the avalanche multiplication film 24 formed by amorphous selenium, and generates electron-hole pairs through a photoelectric conversion. A bias 83 is applied on the avalanche multiplication film 24. In the film, a signal is amplified when holes move from the anode 90 to the cathode 91, and the amplified holes are on the surface of the avalanche multiplication film 24. The cathode 91 contacts with the small bump electrodes 81, so the amplified holes are immediately read by the amplifier 35.

At this time, when the thickness of the avalanche multiplication film 24 is set to 35 μm, and the voltage of the applied bias 83 is set to 3500 V, the signal amplification factor is up to 1000 times, so as to detect the gamma ray with a high sensitivity.

However, at this time, the second embodiment is totally the same as the first embodiment, when the high bias voltage is applied on the avalanche multiplication film 24, it partially becomes the pin-hole defect and results in a short circuit. Therefore, before the anode 90 and the cathode 91 are assembled as a light receiving element, it is necessary to perceive the position of the pin-hole defect in advance. Therefore, the position of the pin-hole defect is specified by using the same method as the first embodiment.

Next, FIG. 10 shows the inspected anode 90 and the processed cathode 91 before being assembled as the light receiving element 201. As it is possible to specify the position of the pin-hole defect 80 in the light receiving surface of the anode 90, the small bump electrode 81 corresponding to the position of the pin-hole defect 85 is not formed on the reading substrate 82 of the cathode 91. The example of FIG. 10 shows the situation in which the small bump electrodes 81 are not formed, and it is possible for the processing to cut the wiring of the small bump electrode 81 corresponding to the position of the pin-hole defect 70.

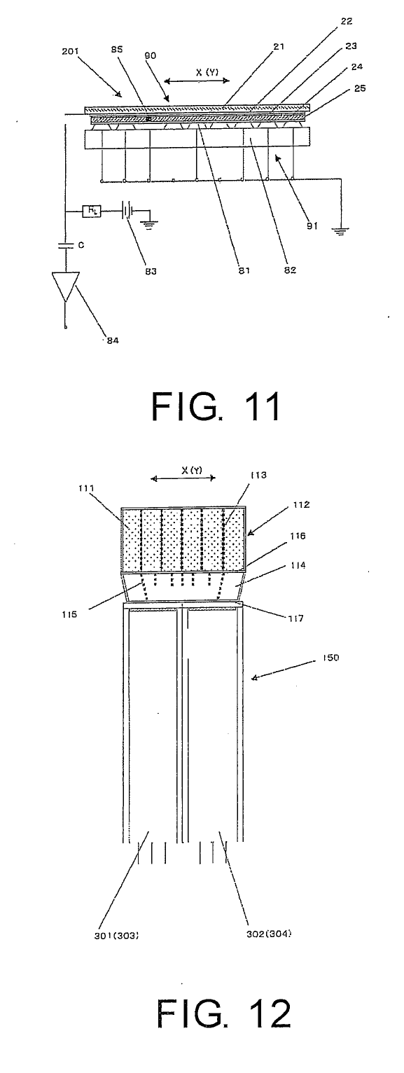

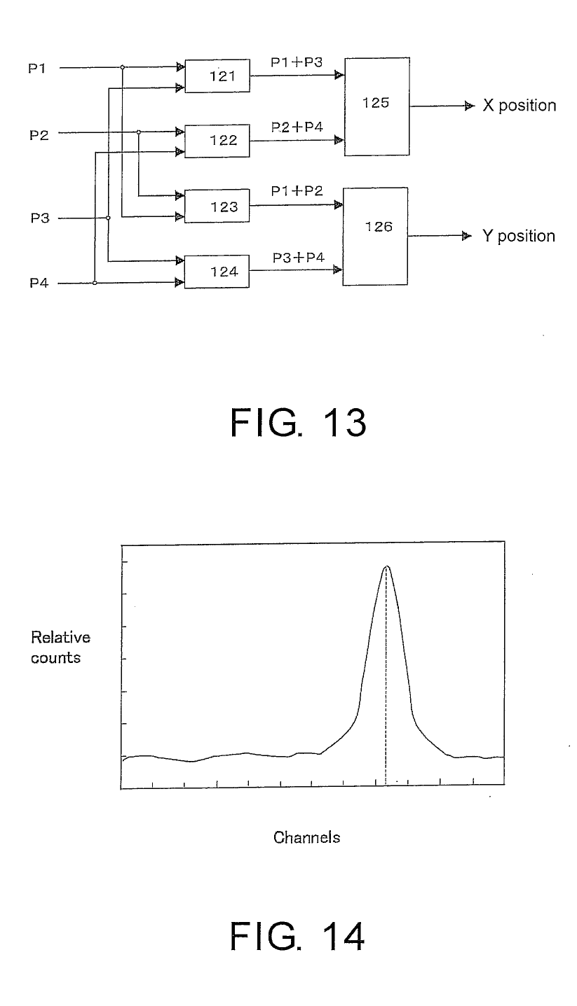

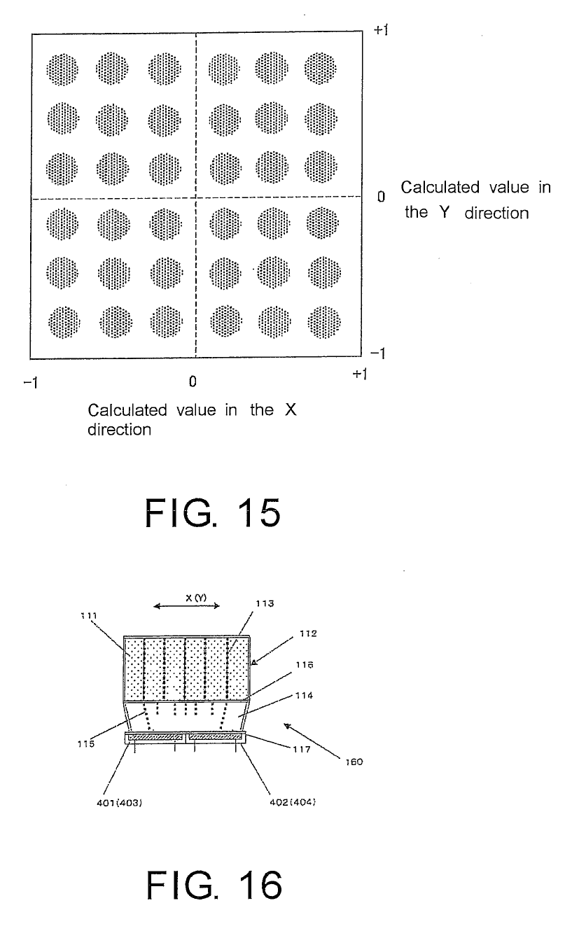

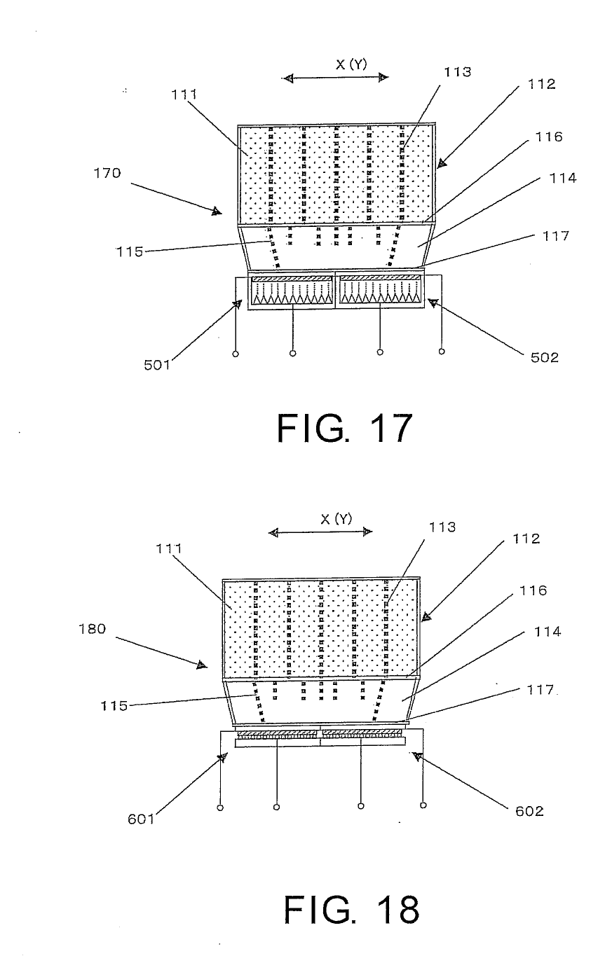

In addition, FIG. 11 shows the situation after the light receiving element 201 is assembled. As described above, the area of the small bump electrode 81 corresponding to the position of the pin-hole defect 85 does not operate, and the area except for this area operates. Therefore, even if the high bias voltage is applied on the avalanche multiplication film 24 in the amorphous selenium film for the signal amplification, it is impossible to become a local pin-hole defect and result in a short circuit, so the area of the light receiving surface except for the pin-hole defect 85 can function normally. At this time, as an insensitive part, the light receiving surface corresponding to the position of the pin-hole defect 85 does not function, but the area of the insensitive part is quite limited and very small, and other parts are sensitive parts. Therefore, the detector can function normally.

As described above, in the radiation detector of the present invention, the avalanche multiplication film 24 and the field emission array 27 are combined and disposed in the vacuum-sealed vacuum enclosure 31. Therefore, the radiation detector of the present invention is quite thin, and the structure of the radiation detector is simple. Compared with the detector using the photomultipliers, the radiation detector of the present invention can be compactly formed. In another aspect, even if the avalanche multiplication film 24 and the reading substrate 82 are combined in the radiation detector of the present invention, the radiation detector is still very thin, and the structure of the radiation detector is simple. Compared with the detector using the photomultipliers, the radiation detector of the present invention can be compactly formed. Therefore, even if under a situation that the space is limited, the detector in a PET device is still very effective. It is different from the photomultiplier requiring a plurality of electrodes, so the structure is simple, and the detector can be realized at a low cost. In addition, for the avalanche multiplication film formed by amorphous selenium, the signal amplification factor is up to 1000 times, so it has a quite high sensitivity, it does not require either an expensive low noise amplifier or a dedicated temperature adjusting mechanism performing the low temperature operation required in the avalanche photodiode. Even if high performance scintillators of LaBr₃:Ce or LaCl₃:Ce etc. are used, the quantum efficiency of the avalanche multiplication film of the scintillator with the luminescence wavelength in the wavelength band of 300-400 nm also achieves 70%, so compared with the photomultipliers or the avalanche photodiodes, it has a quite high efficiency, so as to fully develop the performance of the scintillator. In addition, the position of the pin-hole defect is perceived in advance, so the problem of the generated local pin-hole defect when the high bias voltage is applied on the avalanche multiplication film 24 can be solved by processing the cathode side.

In addition, even if high performance scintillators of LaBr₃:Ce or LaCl₃:Ce etc. with high luminescence and high speed are used, the quantum efficiency of the avalanche multiplication film of the scintillator with the luminescence wavelength in the wavelength band of 300˜400 nm also achieves 70%, so compared with the photomultipliers or the avalanche photodiodes, it has a quite high efficiency, so as to fully develop the performance of the scintillator. In addition, the position of the pin-hole defect is perceived in advance, so the problem of the generated local pin-hole defect when the high bias voltage is applied on the avalanche multiplication film 24 can be solved by processing the cathode side.

### INDUSTRIAL AVAILABILITY

As described above, the present invention is suitable for medical and industrial radioactive imaging devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A radiation detector, comprising a scintillator array performing a light conversion on a radioactive ray, and light receiving elements, wherein the light receiving elements comprise: a vacuum enclosure, disposed on a surface opposite to an incident direction of the radioactive ray of the scintillator array, and being vacuum-sealed; a transparent electrode, disposed in the vacuum enclosure; an avalanche multiplication film, formed on the transparent electrode, sandwiched between barrier layers, and formed by amorphous selenium; and a field emission array, disposed opposite to the avalanche multiplication film and comprising a plurality of field emission chips;
when a defect portion exists on the avalanche multiplication film, the field emission chip at a position opposite to the defect portion is made not to operate.

2. The radiation detector according to claim 1, wherein:
at least one surface of the vacuum enclosure is formed by a transparent glass panel, and the transparent electrode is formed on the transparent glass panel.

3. The radiation detector according to claim 1, wherein:
a light guide for performing light sharing adjustment is disposed between the scintillator array and the light receiving elements.

4. The radiation detector according to claim 1, wherein:
the field emission chip at the position opposite to the defect portion is burnt by a laser, thereby not performing an operation of discharging an electron beam.

5. A radiation detector, comprising: a scintillator array, performing a light conversion on a radioactive ray; a transparent glass panel, disposed on a surface opposite to an incident direction of the radioactive ray of the scintillator array; a transparent electrode, formed on the transparent glass panel; an avalanche multiplication film, formed on the transparent electrode, sandwiched between barrier layers, and formed by amorphous selenium; and a unit, connected to a reading substrate comprising a plurality of small bump electrodes, and thus selectively retrieving a signal, wherein:
when a defect portion exists on the avalanche multiplication film, the small bump electrodes are made to not connect to the defect portion.

6. The radiation detector according to claim 5, wherein:
a light guide for performing a shared light adjustment is disposed between the scintillator array and the light receiving element.

7. The radiation detector according to claim 5, wherein:
the bump electrodes are not formed at a position corresponding to the defect portion of the avalanche multiplication film.

8. An inspecting method of a radiation detector, wherein:
in a vacuum container for specifying a defect position having a field emission array for inspection, a transparent glass panel and a transparent electrode formed on the transparent glass panel are disposed opposite to an avalanche multiplication film formed on the transparent electrode and sandwiched between barrier layers, and a position of a defect portion generated in an avalanche operation on the avalanche multiplication film is specified.
